(19) United States
(12) Patent Application Publication
(10) Pub. No.: US 2013/0088186 A1
(43) Pub. Date: Apr. 11, 2013

(54) CHARGER

(71) Applicant: FANG-KENG HSIEH, Tu-Cheng (TW)

(72) Inventor: FANG-KENG HSIEH, Tu-Cheng (TW)

(73) Assignee: HON HAI PRECISION INDUSTRY CO., LTD., Tu-Cheng (TW)

(21) Appl. No.: 13/304,315

(22) Filed: Nov. 24, 2011

(30) Foreign Application Priority Data
Oct. 11, 2011 (CN) 201110306376.1

(51) Int. Cl. H02J 7/00

(52) U.S. Cl. 320/103

(57) ABSTRACT

An exemplary charger is to charge an electronic device, which includes one first contact. The charger includes a housing, a lithium battery, a circuit board. The housing includes a top cover and a bottom cover attached to the top cover. The top cover defines at least one through hole. The lithium battery is fixed in the housing. The lithium battery is electrically connected to the circuit board. The circuit board includes a second contact. The second contact passes through the through hole and is external to the top cover. When the at least one first contact contacts the at least one second contact, an electrical connection is created between the electronic device and the charger, the charger charges the electronic device through the lithium battery.

### BACKGROUND

1. Technical Field

The present disclosure relates to chargers and, particularly, to a charger capable of charging an electronic device when a power source is not available.

2. Description of Related Art

A portable charger is a conventional device to charge an electronic device. The conventional portable charger is connected to a power source when charging the electronic device. When the power source is not available, the charger cannot charge the electronic device.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view showing a charger charging an electronic device in accordance with an exemplary embodiment.

FIG. 2 is a schematic view of the charger of FIG. 1.

FIG. 3 is an exploded view of the charger of FIG. 2.

### DETAILED DESCRIPTION

The embodiments of the present disclosure are now described in detail, with reference to the accompanying drawings.

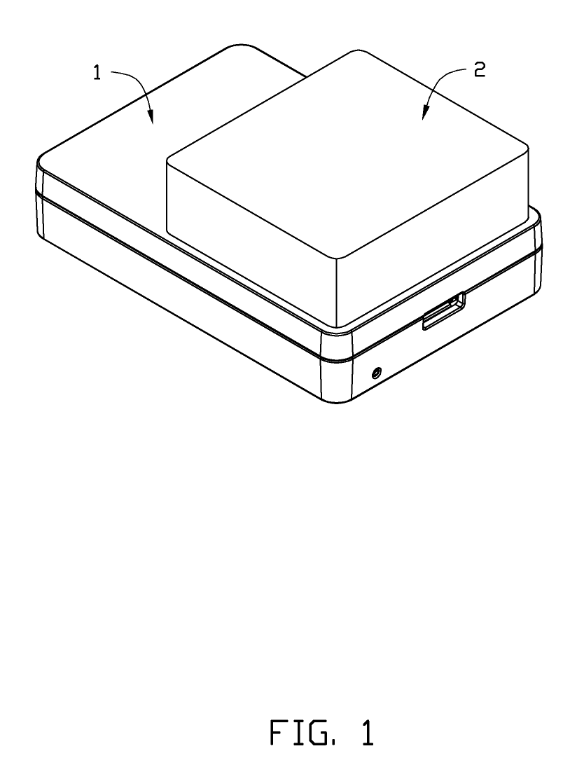

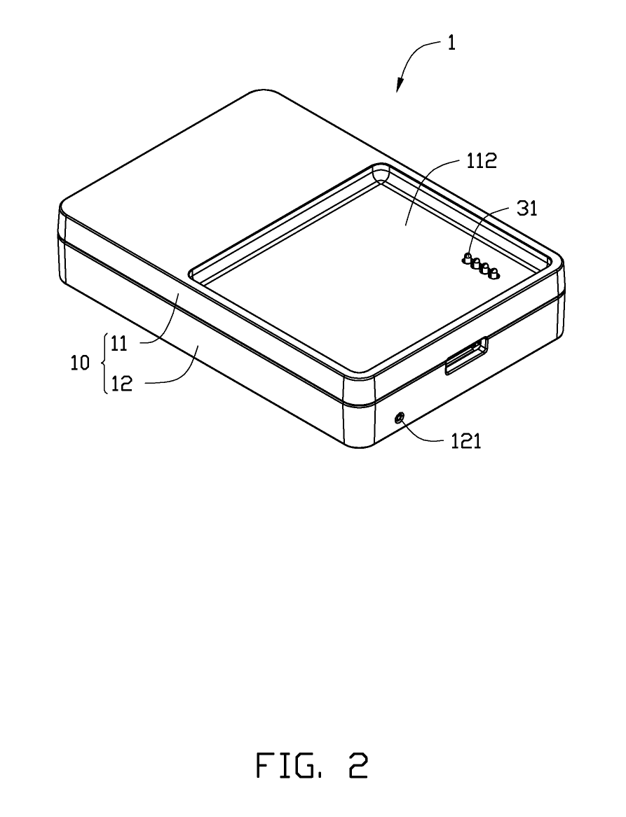

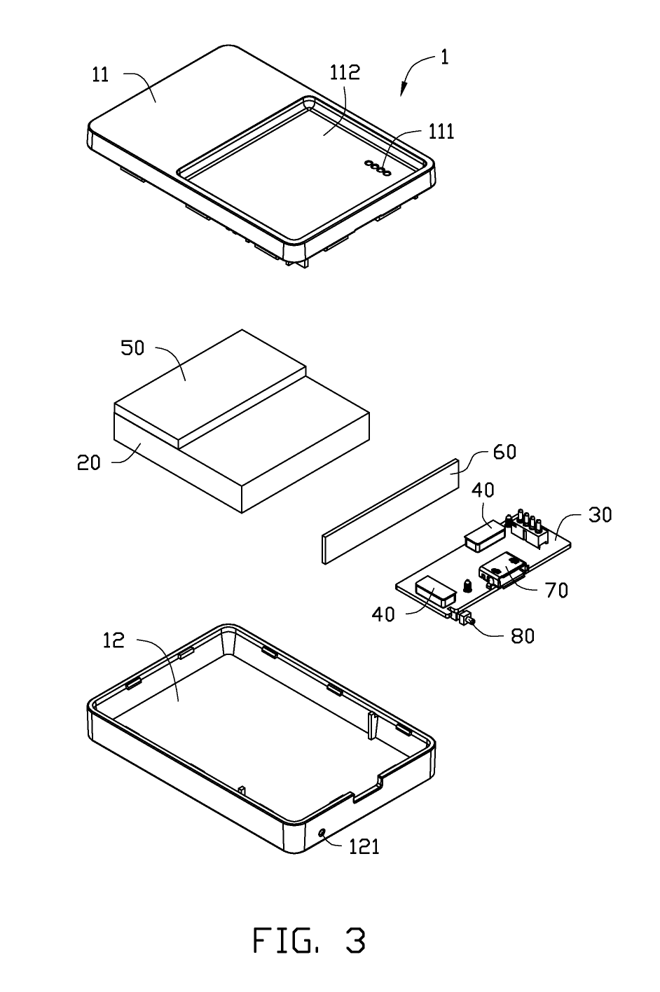

Referring to FIGS. 1-3, a charger 1 in accordance with an exemplary embodiment is provided. In the embodiment, the charger 1 is used to charge an electronic device 2, such as a wrist worn device. In other embodiments, the charger 1 can be used to charge a battery of just about any electronic device. The electronic device 2 includes at least one first contact. In the embodiment, the electronic device 2 includes a metal casing. Alternatively, the casing may be made of ferromagnetic material. The charger 1 includes a housing 10, at least one lithium battery 20, and a circuit board 30. The at least one lithium battery 20 and the circuit board 30 are arranged in the housing 10.

The housing 10 includes a top cover 11 and a bottom cover 12. The top cover 11 is attached to the bottom cover 12. The top cover 11 defines at least one first through hole 111. In the embodiment, the top cover 11 and the bottom cover 12 are made of insulated material.

The at least one lithium battery 20 and the circuit board 30 are fixed in the bottom cover 12. The at least one lithium battery 20 is electrically connected to the circuit board 30. At least one second contact 31 is electrically connected to the circuit board 30. The at least one second contact 31 passes through the first through hole 111 and is external to the top cover 11.

To charge the electronic device 2, the electronic device 2 is placed on the top cover 11 to cause the at least one second contact 31 to contact the at least one first contact, thereby creating an electrical connection between the electronic device 20 and the charger 1. The charger 1 can then charge the electronic device 2 through the at least one lithium battery 20.

In the embodiment, the top cover 11 further defines a cavity 112 to receive and position the electronic device 2. The at least one first through hole 111 is defined in the bottom of the cavity 112. The charger 1 further includes at least one magnet 40, at least one heat sink 50, a protection circuit 60, a USB interface 70, and at least one indicator 80.

The at least one magnet 40 is fixed in the bottom cover 12, under the cavity 112. In the embodiment, the at least one magnet 40 is an electromagnet. The at least one magnet 40 produces magnetic field to attract the electronic device 2 in the cavity 112 of the top cover 11 when electric current flows through the at least one magnet 40.

The at least one heat sink 50 is fixed to the at least one lithium battery 20 to cool the at least one lithium battery 20. In the embodiment, the heat sink 50 is a graphite piece.

The protection circuit 60 is electrically connected to the at least one lithium battery 20 to protect the at least one lithium battery 20.

The USB interface 70 is electrically connected to the circuit board 30. The USB interface 70 can connect with an external USB cable to charge the at least one lithium battery 20 and the electronic device 2 when a power source is supplied through the USB cable.

The at least one indicator 80 is electrically connected to the circuit board 30. The bottom cover 12 further defines at least one second through hole 121. The at least one indicator 80 passes through the at least one second through hole 121 and is external to the bottom cover 12 to prompt the user that the charger 1 is charging the electronic device 2 and that the charging of the electronic device 2 is completed. In the embodiment, the number of indicators is one, when the indicator emits light of a first color, such as red, the charger 1 is charging the electronic device 2, when the indicator 80 emits light of a second color, such as blue, the charging of the electronic device 2 is completed. In other embodiments, the number of the indicators 80 can be varied according to need.

In this way, the charger 1 can charge the electronic device 2 and the lithium battery 20 through the USB interface 70 when a power source is supplied. In addition, when the power source is not available, the charger 1 can charge the electronic device 2 through the lithium battery 20.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A charger configured to charge an electronic device comprising at least one first contact, the charger comprising:
a housing comprising a top cover and a bottom cover attached to the top cover, the top cover defining at least one through hole;
at least one lithium battery fixed in the housing; and
a circuit board fixed in the bottom cover, the at least one lithium battery being electrically connected to the circuit board, the circuit board comprising at least one second contact, the at least one second contact passing through the at least one through hole and being external to the top cover;
wherein when the at least one first contact contacts the at least one second contact, an electrical connection is created between the electronic device and the charger, the charger charges the electronic device through the least one lithium battery.

2. The charger as described in claim 1, wherein the top cover further defines a cavity to receive and position the electronic device, the at least one through hole is defined in a bottom of the cavity.

3. The charger as described in claim 1, further comprising at least one magnet, wherein the at least one magnet is fixed in the bottom cover to attract the electronic device.

4. The charger as described in claim 1, further comprising a protection circuit to protect the lithium battery.

5. The charger as described in claim 1, further comprising at least one heat sink, wherein the at least one heat sink is fixed to the at least one lithium battery to cool the at least one lithium battery.

6. The charger as described in claim 1, further comprising a USB interface electrically connected to the circuit board, wherein the USB interface is configured to connect with an external USB cable.

7. The charger as described in claim 1, further comprising at least one indicator electrically connected to the circuit board, wherein the at least one indicator is configured to prompt the user that the charger is charging the electronic device and that the charging of the electronic device is complete.
